(19) United States
(12) Patent Application Publication
(10) Pub. No.: US 2016/0318160 A1
(43) Pub. Date: Nov. 3, 2016

(54) DOUBLE SHULDER FEMALE SOCKET AND METHOD FOR OPTIMIZING A TORQUE TRANSMITTING RELATION BETWEEN A SOCKET WRENCH AND A DOUBLE SHOULDERED NUT

(71) Applicant: Charlie R. Hon, Yorba Linda, CA (US)

(72) Inventor: Charlie R. Hon, Yorba Linda, CA (US)

(21) Appl. No.: 14/698,685

(22) Filed: Apr. 28, 2015

(51) Int. Cl. B25B 13/50; B25B 13/06

(52) U.S. Cl. CPC B25B 13/50; B25B 13/065

(57) ABSTRACT

A double shoulder female socket that engages the maximum contact surface area of a double shouldered nut to transmit the optimal torque from an attached wrench socket. The double shoulder female socket includes a first shoulder and a second shoulder that engage the respective shoulders, cap, and outer walls of the double shouldered nut, so as to maximize contact and inhibit slippage and stripping. The double shoulder female socket further includes at least one first guidance channel and second guidance channel on the respective corner points that grip the nut and help guide the nut into the most efficient coupling configuration with the double shoulder female socket.

### BACKGROUND OF THE INVENTION

1. Field of the Invention

This invention relates to a female socket that forms an endpoint for communication between a wrench and a nut; and more particularly a double shoulder female socket that optimizes a torque transmitting relation between a socket wrench and a double shouldered nut by maximizing contact between the respective shoulders and contact surface areas of the double shoulder female socket and the double shouldered nut.

2. Description of the Related Art

Generally, a socket is a tool with an opening or hollow into which a linear tool, such as a socket wrench, pipe, or probe can be fitted. Often, the socket includes a smooth circular periphery and a cavity that is contoured to fixedly couple to a fastener, such as a nut or bolt. Often, the female socket is rotated by a socket wrench, power tool, or by hand. The female socket is often a hexagonal socket that can range in diameter size from 3/16″ to ¾″ in sixteenth inch increments.

Typically, the female socket is operatively attached to a socket wrench having a generally square-shaped stud or tang. The square-shaped stud detachably couples to the female socket to enable multidirectional rotation to tighten or loosening of a fastener, such a nut or bolt. In this manner, the rotational torque is more effectively transmitted to the fastener. Once attached to the socket wrench, the cavity of the socket rotatably engages a nut or bolt having similarly sized dimensions as the opening in the socket to tighten or loosen the nut, as needed.

Typically, a double shouldered nut is a type of fastener that has a cap and at least one outer shoulder spaced below the cap. The double shouldered cap may also be threaded for rotational fastening to a mounting surface. Often, the double shouldered nut is used to affix the front sprockets of a motorcycle. A female socket is often used to engage the double shouldered nut for the desired adjustments.

In many instances, the contact surface area between the female socket and the double shouldered nut is slim. The space between the contours is often large, leaving a gap. Additionally, the contour of the second shoulder on the double shouldered nut disengages other surface areas from the female socket, such that the double shouldered nut is stripped and the rotation is not optimal. Consequently, the maximum amount of torque is not transferred from the socket wrench to the double shouldered nut.

Current methods and apparatii do not readily provide female sockets with double shoulders that substantially match the contour of the double shouldered nut. It is therefore desirable that a double shoulder female socket optimizes a torque transmitting relation between a socket wrench and a double shouldered nut by maximizing contact between the respective shoulders and surface areas of the double shoulder female socket and the double shouldered nut.

### SUMMARY OF THE INVENTION

From the foregoing discussion, it should be apparent that a need exists for a double shoulder female socket that forms an endpoint for communication between a socket wrench and a double shouldered nut to optimize the transmittal of torque by maximizing surface area contact between the shoulders, sidewalls, and contact surface areas of the female socket and the double shouldered nut.

Beneficially, such a female socket would overcome many of the difficulties of the prior art by providing a double shoulder female socket that engages the maximum contact surface area of a double shouldered nut to transmit the optimal torque from an operatively attached wrench socket. The double shoulder female socket includes a first shoulder and a second shoulder that engage the respective shoulders, cap, and outer walls of the double shouldered nut, so as to maximize contact, and thereby inhibit slippage and stripping between the female socket and the double shouldered nut. The double shoulder female socket further includes at least one first guidance channel and second guidance channel on the respective corner points that grip the nut and help guide the nut into the most efficient coupling configuration with the double shoulder female socket.

The present invention has been developed in response to the present state of the art, and in particular, in response to the problems and needs in the art that have not yet been fully solved by currently available apparatii and methods. Accordingly, the present invention has been developed to provide a female socket with two shoulders that substantially match the two shoulders of a double shouldered nut for maximum contact between surface areas.

The double shoulder female socket, hereafter, “female socket” forms an endpoint for communication between a socket wrench and a double shouldered nut. The female socket maximizes contact with the surface area on the cap, outer shoulders, and sidewalls of a double shouldered nut. In this manner, as torque and shear forces are applied to the female socket, the transmittal of torque to the double shouldered nut is maximized.

The double shouldered nut is generally used to adjust a front sprocket of a motorcycle. Though, the female socket may be used to engage and transmit torque to any nut having at least one outer shoulder, outer ridge, and series of parallel planes on the outer wall.

The female socket includes a first shoulder and a second shoulder that engage the respective caps, outer shoulders, and outer sidewalls of the double shouldered nut. In this manner, surface area contact is maximized with the shoulders and first walls of the double shouldered nut. This creates a snug mating configuration that helps eliminate stripping of the double shouldered nut and generates the maximum amount of torque during rotational adjustments of the double shouldered nut.

The double shoulder female socket further includes a plurality of corner points having second and first guidance channels. The corner points substantially align with points on the double shouldered nut, serving as grips. The guidance channels form a parallel, spaced-apart arrangement along the length of both second and first sidewalls. The guidance channels serve as grips, and also serve to help guide the double shouldered nut into the most efficient mating configuration with the double shoulder female socket.

In one embodiment, the double shoulder female socket comprises a generally elongated housing. The housing may form a smooth circular periphery. The housing is defined by a mount end having a mount opening, and a nut end having a nut opening. The nut opening is disposed axially opposite the mount opening.

The double shoulder female socket further comprises a first sidewall. The first sidewall is defined by a plurality of first points and at least one first guidance channel. In one embodiment, six first points create a hexagonal shaped first sidewall. Additionally, six guidance channels form a parallel, spaced-apart arrangement along the length of the first sidewall.

The first sidewall is disposed to extend along the length of the housing from the nut opening to a first shoulder. The first shoulder is disposed substantially perpendicular to the first sidewall. In some embodiments, the first sidewall and the first shoulder are configured to engage a nut cap on the double shouldered nut.

The double shoulder female socket further comprises a second sidewall. The second sidewall is generally longer than the first sidewall and extends deeper into the housing. The second sidewall is defined by a plurality of second points and at least one second guidance channel. In one embodiment, six second points create a hexagonal shaped second sidewall. Additionally, six guidance channels form a parallel, spaced-apart arrangement along the length of the second sidewall.

The second sidewall is disposed to extend along the length of the housing from the first shoulder to a second shoulder. The second shoulder is disposed substantially perpendicular to the first sidewall. In some embodiments, the second sidewall and the second shoulder are configured to engage a shoulder on the double shouldered nut.

The female socket, in one embodiment, is configured to adjust a double shouldered nut for affixing a front sprocket of a motorcycle.

The female socket, in yet another embodiment, is configured to maximize contact with the surface area of a double shouldered nut, including the cap, the nut outer wall, and the nut shoulder, so as to minimize stripping of the double shouldered nut.

The female socket, in another embodiment, is configured to provide two discrete shoulders that are spaced-apart at a distance that correlates to the distance between the cap and the nut shoulder in the double shouldered nut.

The female socket, in yet another embodiment, is configured to provide a square-shaped mount opening that detachably couples to a square-shaped stud on the socket wrench.

The female socket, in yet another embodiment, is configured to provide points at the corners of the sidewalls that grip the outer wall of the double shouldered nut.

The female socket, in yet another embodiment, is configured to provide guidance channels that grip the outer wall of the double shouldered nut and help guide the double shouldered nut into the housing.

A method of the present invention is also presented for optimizing the torque transmitting relation between a wrench and a double shouldered nut with a double shoulder female socket. The method comprises: providing a double shoulder female socket; coupling a square drive stud of a socket wrench with a mount end of a housing; aligning a nut opening with a double shouldered nut; engaging a second shoulder and a second sidewall with a nut shoulder from the double shouldered nut; engaging a first shoulder and a first sidewall with a nut cap from the double shouldered nut; and rotating the socket wrench such that a maximum amount of torque is transmitted from the double shoulder female socket to the double shouldered nut.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a top perspective view of a double shoulder female socket facing a nut end of a housing in accordance with the present invention;

FIG. 2 is a side perspective view of a double shoulder female socket facing a nut end of a housing in accordance with the present invention;

FIG. 3 is a bottom perspective view of a double shoulder female socket facing a mount end of a housing in accordance with the present invention;

FIG. 4 is a side perspective view of a double shoulder female socket facing a mount end of a housing in accordance with the present invention; and

FIG. 5 is a flowchart diagram of method for optimizing the torque transmitting relation between a wrench and a double shouldered nut with a double shoulder female socket in accordance with the present invention.

### DETAILED DESCRIPTION OF THE INVENTION

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

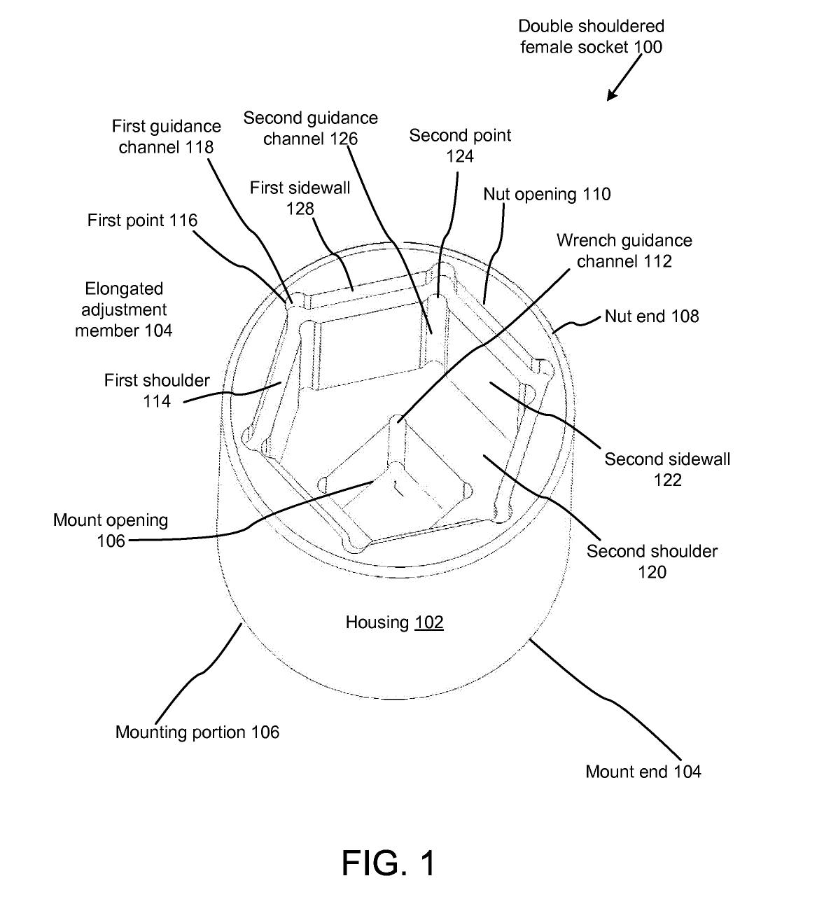

As referenced in FIGS. 1-5, a double shoulder female socket 100, hereafter, “female socket” forms an endpoint for communication between a socket wrench (not shown) and a double shouldered nut (not shown). The female socket 100 maximizes contact with the surface area on the shoulders, cap, and outer sidewalls of the double shouldered nut. In this manner, as torque and shear forces are applied to the female socket, the transmittal of torque to the double shouldered nut is maximized.

The double shouldered nut is generally used to adjust a front sprocket (not shown) of a motorcycle. However, in other embodiments, the female socket 100 may be used to engage and transmit torque to any nut having at least one outer shoulder, outer ridge, or a series of parallel planes on the outer walls.

In some embodiments, the female socket 100 may be operatively attached to a socket wrench having a generally square-shaped stud or tang. The square-shaped stud detachably couples to the female socket 100 to enable multidirectional rotation to tighten or loosen the double shouldered nut, as needed. However, in other embodiments, the female socket 100 may be rotated by hand or with a power tool. In one embodiment, the female socket 100 comprises female hexagonal sockets that range in diameter size from 3/16″ to ¾″ in sixteenth inch increments.

The female socket 100 is configured to provide two discrete shoulders that are spaced-apart at a distance that correlates to the distance between the cap and outer shoulder of the double shouldered nut. In one possible embodiment, the female socket 100 includes a first shoulder 114 and a second shoulder 120 that engage the respective caps, outer shoulders, and outer sidewalls of the double shouldered nut.

In this manner, surface area contact with the double shouldered nut is maximized. This creates a snug mating configuration that helps eliminate stripping of the double shouldered nut and generates the maximum amount of torque during rotational adjustments of the double shouldered nut. Additionally, rotational slippage is minimized since the contour of the female socket 100 substantially matches the outer contour of the double shouldered nut.

The double shoulder female socket 100 further includes a plurality of first and second points 116, 124 at the corners of the respective sidewalls 122, 128. At least one first and second guidance channel 118, 126 also extends down the sidewalls 122, 128. The points 116, 124 substantially align with corners, ridges, and protrusions on the double shouldered nut, whereby a gripping configuration forms therebetween. The guidance channels 118, 126 form a parallel, spaced-apart arrangement along the length of both second and first sidewalls 122, 128. The guidance channels 118, 126 also serve as grips, and help guide the double shouldered nut into the most efficient mating configuration with the double shoulder female socket 100.

As referenced in FIG. 1, the double shoulder female socket 100 comprises a generally elongated housing 102. The housing 102 may form a smooth circular periphery. In some embodiments, ridges or flutes on the outer surface of the housing 102 may be added to inhibit rolling by the female socket 100. Suitable materials for the housing 102 may include, without limitation, steel, iron, and metal alloys.

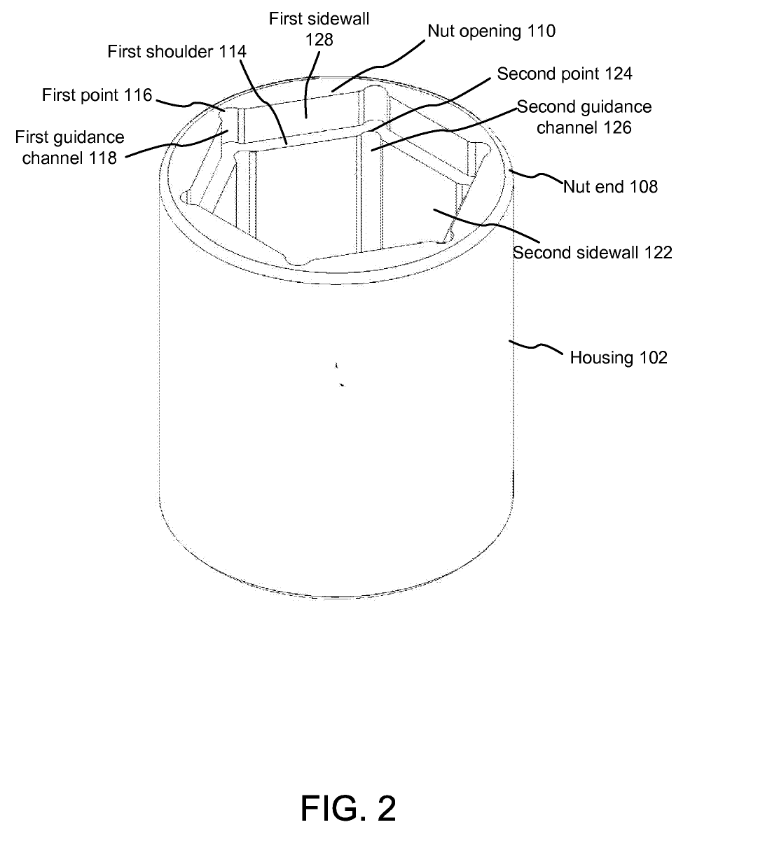

The housing 102 is defined by a mount end 104 having a mount opening 106. In one embodiment, the mount end 104 is defined by a square-shaped mount opening 106 that detachably couples to a square-shaped stud on the socket wrench. In another embodiment, the mount opening 106 comprises four wrench corner points and four wrench guidance channels 112. The four wrench guidance channels 112 are configured to help guide the square drive stud of the socket wrench into a coupling configuration with the mount opening 106. Turning now to FIG. 2, the housing 102 further comprises a nut end 108 having a nut opening 110. The nut opening 110 is disposed axially opposite the mount opening 106. In one embodiment, the nut opening 110 comprises a generally hexagonal shape.

Referencing back to FIG. 1, the female socket 100 further comprises a first sidewall 128. The first sidewall 128 is defined by a plurality of first points 116 and at least one first guidance channel 118. The at least one first guidance channel 118 extends radially coterminous with the nut end 108. In one embodiment, six first points 116 create a hexagonal shaped first sidewall 128. Additionally, six guidance channels 118 form a parallel, spaced-apart arrangement along the length of the first sidewall 128.

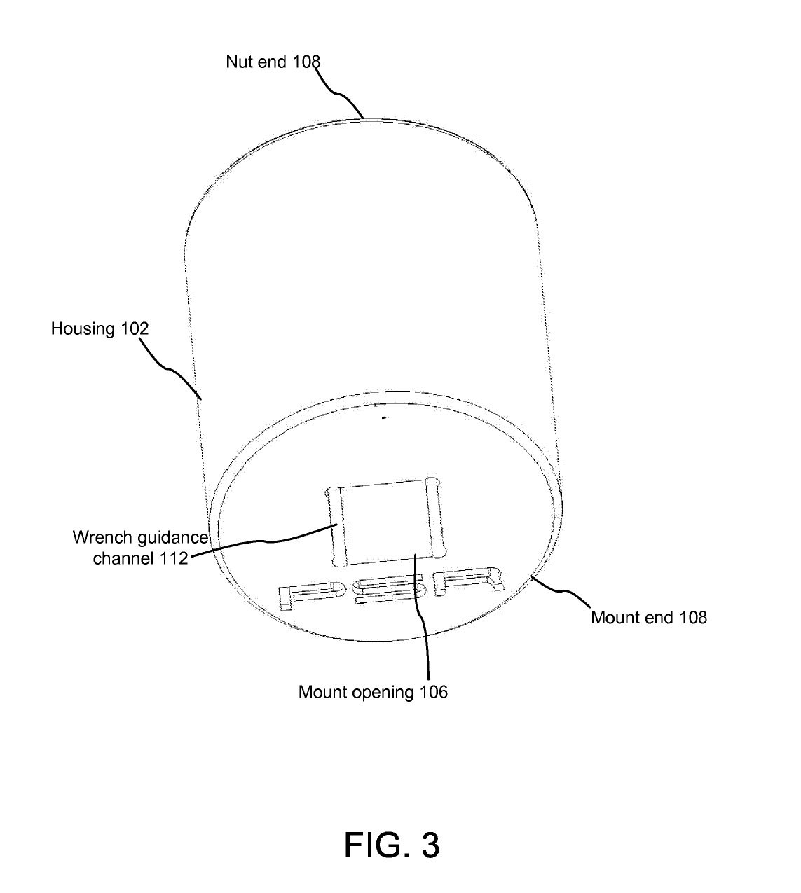

As illustrated in FIG. 3, the first sidewall 128 is disposed to extend along the length of the housing 102 from the nut opening 110 to a first shoulder 114. The first shoulder 114 is disposed substantially perpendicular to the first sidewall 128. The first shoulder 114 may engage the cap of the double shouldered nut, flush during rotation. In some embodiments, the first sidewall 128 and the first shoulder 114 are configured to engage a nut cap on the double shouldered nut.

The female socket 100 further comprises a second sidewall 122. The second sidewall 122 is generally longer than the first sidewall 128, extending deeper into the housing 102. The second sidewall 122 is defined by a plurality of second points 124 and at least one second guidance channel 126. The at least one second guidance channel 126 extends radially coterminous with the first shoulder 114.

In one embodiment, six second points 124 create a hexagonal shaped second sidewall 122. Additionally, six second guidance channels 126 form a parallel, spaced-apart arrangement along the length of the second sidewall 122. The second sidewall 122 is disposed to extend along the length of the housing 102 from the first shoulder 114 to a second shoulder 120. The second shoulder 120 is disposed substantially perpendicular to the first sidewall 128.

In some embodiments, the second sidewall 122 and the second shoulder 120 are configured to engage a shoulder on the double shouldered nut, flush during rotation. This flush engagement between shoulders 114, 120 and caps, outer shoulders, and outer walls eliminates loosens during rotation, which increases the transmittal of torque to the double shouldered nut.

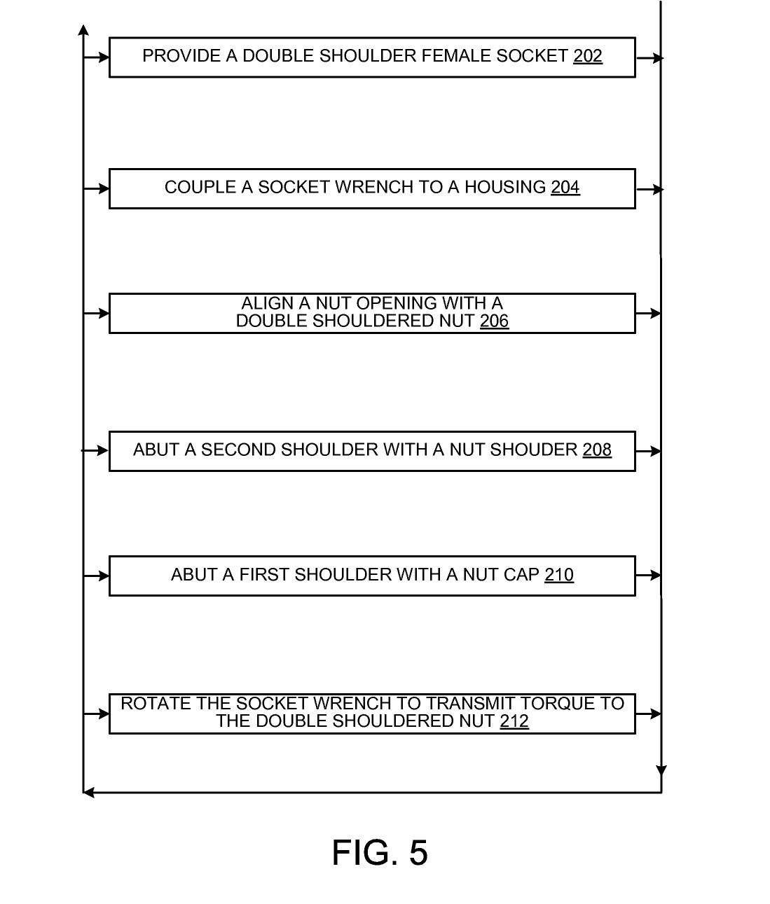

FIG. 5 illustrates a flowchart diagram of an exemplary method 200 for optimizing the torque transmitting relation between a socket wrench and a double shouldered nut with a double shoulder female socket 100. The method 200 may include an initial Step 202 of providing a double shoulder female socket 100. The female socket 100 is substantially tubular shape and is sufficiently rigid to grip and rotate a double shouldered nut having substantially the same contour. The female socket 100 is configured to provide two discrete shoulders 114, 120 that are spaced-apart at a distance that correlates to the distance between the cap and the nut shoulder in the double shouldered nut.

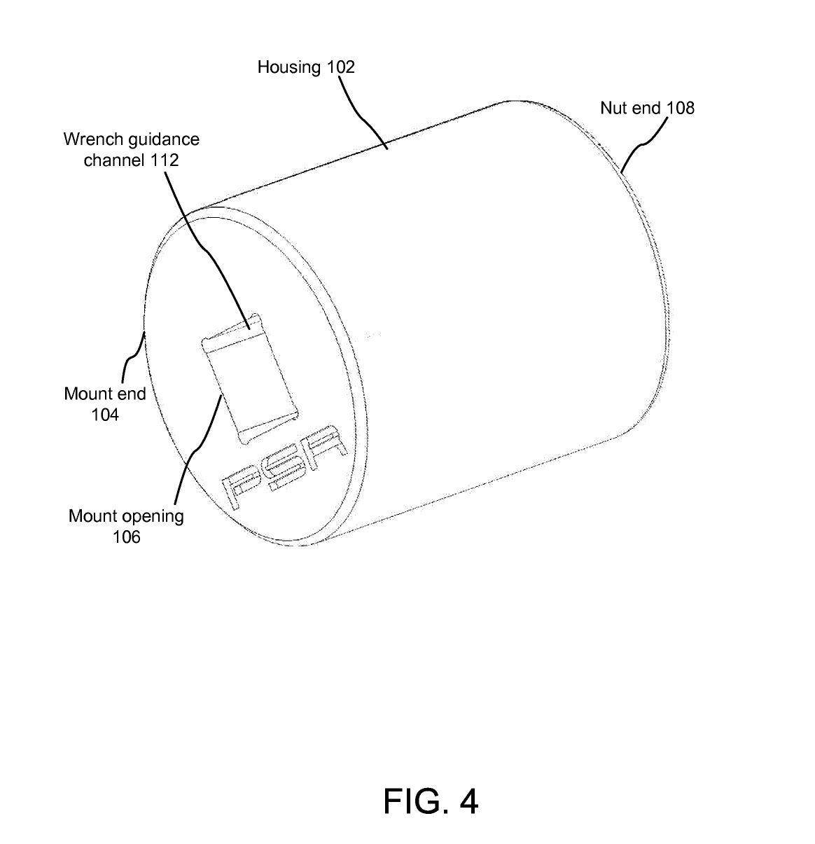

The method 200 may further comprise a Step 204 of coupling a square drive stud of a socket wrench to a mount end 104 of a housing 102 of the female socket 100 (FIG. 4). The female socket 100 may be operatively attached to a socket wrench having a generally square-shaped stud or tang. The square-shaped stud detachably couples to the female socket 100 to enable multidirectional rotation to tighten or loosen the double shouldered nut, as needed. In this manner, the rotational torque is more effectively transmitted to the uniquely shaped double shouldered nut.

A Step 206 includes aligning a nut opening 110 with a double shouldered nut. The housing 102 has a nut opening 110 on a nut end 108 that substantially matches the dimensions of the double shouldered nut. The double shouldered nut is fit inside the cavity of the housing 102. In some embodiments, a Step 208 comprises abutting a second shoulder 120 and a second sidewall 122 with a nut shoulder from the double shouldered nut. A Step 210 includes abutting a first shoulder 114 and a first sidewall 128 with a nut cap from the double shouldered nut. This flush engagement between the shoulders 114, 120 and the caps, outer shoulders, and outer wall of the double shouldered nut inhibits gaps therebetween and undesirable movements during rotation. This tight, efficient fit consequentially increases the transmittal of torque to the double shouldered nut.

A final Step 212 includes rotating the socket wrench such that a maximum amount of torque is transmitted from the double shoulder female socket 100 to the double shouldered nut. After the abutment between the different surface areas, sufficient frictional engagement is created, such that surface area contact with the double shouldered nut is maximized. This creates a snug mating configuration that helps eliminate stripping of the double shouldered nut and generates the maximum amount of torque during rotational adjustments of the double shouldered nut. Additionally, rotational slippage is minimized since the contour of the female socket 100 substantially matches the outer contour of the double shouldered nut.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A double shoulder female socket for optimizing the torque transmitting relation between a wrench and a double shouldered nut, the socket comprising:
a housing, the housing defined by a mount end having a mount opening, and a nut end having a nut opening, the nut opening disposed axially opposite the mount opening;
a first sidewall, the first sidewall defined by a plurality of first points and at least one first guidance channel, the first sidewall disposed to extend along the length of the housing from the nut opening to a first shoulder, the first shoulder disposed substantially perpendicular to the first sidewall; and
a second sidewall, the second sidewall defined by a plurality of second points and at least one second guidance channel, the second sidewall disposed to extend along the length of the housing from the first shoulder to a second shoulder, the second shoulder disposed substantially perpendicular to the first sidewall.

2. The socket of claim 1, wherein the socket is configured to engage a double shouldered nut.

3. The socket of claim 1, wherein the housing forms a smooth circular periphery.

4. The socket of claim 1, wherein the housing is steel.

5. The socket of claim 1, wherein the mount end is configured to enable fastenable coupling with a square-drive stud of a socket wrench.

6. The socket of claim 5, wherein the mount opening comprises four corner wrench points and four wrench guidance channels, the four wrench guidance channels configured to help guide the square drive stud into a coupling configuration with the mount opening.

7. The socket of claim 1, wherein the mount opening forms a substantially square shape.

8. The socket of claim 1, wherein the plurality of first points comprises six corner points.

9. The socket of claim 1, wherein the plurality of first points have a substantially semi-circular shape.

10. The socket of claim 1, wherein the at least one first guidance channel comprises six first guidance channels forming a parallel, spaced-apart arrangement along the length of the first sidewall.

11. The socket of claim 1, wherein the at least one first guidance channel extends radially coterminous with the nut end.

12. The socket of claim 1, wherein the second sidewall has a lesser diameter than the first sidewall.

13. The socket of claim 1, wherein the plurality of second points comprises six corner points.

14. The socket of claim 1, wherein the plurality of second points have a substantially semi-circular shape.

15. The socket of claim 1, wherein the at least one second guidance channel comprises six second guidance channels forming a parallel, spaced-apart arrangement along the length of the second sidewall.

16. The socket of claim 1, wherein the at least one second guidance channel extends radially coterminous with the first shoulder.

17. The socket of claim 1, wherein the second sidewall forms a substantially hexagon shape.

18. The socket of claim 1, wherein the nut opening forms a substantially hexagon shape.

19. A double shoulder female socket for optimizing the torque transmitting relation between a wrench and a double shouldered nut, the socket comprising:
a housing, the housing defined by a mount end having a mount opening, and a nut end having a nut opening, the mount opening comprising four corner points and four guidance channels, the nut opening disposed axially opposite the mount opening;
a first sidewall, the first sidewall defined by six first points and six guidance channels, the first sidewall disposed to extend along the length of the housing from the nut opening to a first shoulder, the first shoulder disposed substantially perpendicular to the first sidewall; and
a second sidewall, the second sidewall defined by six second points and six guidance channels, the second sidewall disposed to extend along the length of the housing from the first shoulder to a second shoulder, the second shoulder disposed substantially perpendicular to the first sidewall.

20. A method for optimizing the torque transmitting relation between a wrench and a double shouldered nut with a double shoulder female socket, the method comprising:
providing a double shoulder female socket;
coupling a square drive stud of a socket wrench with a mount end of a housing;
aligning a nut opening with a double shouldered nut;
abutting a second shoulder and a second sidewall with a nut shoulder from the double shouldered nut;
abutting a first shoulder and a first sidewall with a nut cap from the double shouldered nut;
rotating the socket wrench such that a maximum amount of torque is transmitted from the double shoulder female socket to the double shouldered nut.
